(19) United States
(12) Patent Application Publication
(10) Pub. No.: US 2025/0314245 A1
(43) Pub. Date: Oct. 9, 2025

(54) FLUID CONTROL DEVICE

(71) Applicant: Murata Manufacturing Co., Ltd., Nagaokakyo-shi (JP)

(72) Inventor: Yutoku KAWABATA, Nagaokakyo-shi (JP)

(21) Appl. No.: 19/240,034

(22) Filed: Jun. 17, 2025

Related U.S. Application Data
(63) Continuation of application No. PCT/JP2023/042035, filed on Nov. 22, 2023.

(30) Foreign Application Priority Data
Dec. 23, 2022 (JP) 2022-206142

(51) Int. Cl. F04B 43/04

(52) U.S. Cl. CPC F04B 43/046

(57) ABSTRACT

A fluid control device includes a first flat plate, a second flat plate, and a side wall. The first flat plate includes a vibrator at which a piezoelectric device is disposed, a frame disposed to surround the vibrator, a support member that connects the vibrator and the frame to each other, and a first opening formed between the vibrator and the frame. The second flat plate has a first main surface that faces the vibrator, and includes a second opening. The side wall is disposed between the frame of the first flat plate and the second flat plate to be connected to the first flat plate and the second flat plate, and the side wall is annular. The second flat plate includes an annular recess set back from the first main surface.

### CROSS REFERENCE TO RELATED APPLICATION

This is a continuation of International Application No. PCT/JP2023/042035 filed on Nov. 22, 2023, which claims priority from Japanese Patent Application No. 2022-206142 filed on Dec. 23, 2022. The contents of these applications are incorporated herein by reference in their entireties.

### BACKGROUND OF THE DISCLOSURE

### Field of the Disclosure

The present disclosure relates to a fluid control device using vibrations of a piezoelectric body.

### Description of the Related Art

International Publication No. 2020/111063 describes a fluid control device including a piezoelectric body. The fluid control device according to International Publication No. 2020/111063 includes a vibration plate to which the piezoelectric body is connected, a top plate, and a side wall.

The vibration plate and the top plate are disposed at a distance from each other. The side wall is connected to an outer peripheral portion of the top plate to surround a space between the vibration plate and the top plate. In this structure, the vibration plate, the top plate, and the side wall define a pump chamber. The vibration plate and the top plate each have an opening. Thus, the pump chamber is connected to a space outside the fluid control device through the opening in the vibration plate and the opening in the top plate.

The fluid control device according to International Publication No. 2020/111063 applies a driving signal to the piezoelectric body to vibrate the vibration plate. For example, the fluid control device then sucks a fluid (such as a gas) into the pump chamber through the opening in the vibration plate, transports the fluid in the pump chamber, and ejects the fluid through the opening in the top plate.

### BRIEF SUMMARY OF THE DISCLOSURE

However, in the fluid control device according to International Publication No. 2020/111063, as the pressure distribution in the pump chamber changes with time based on vibrations of the vibration plate, the top plate also vibrates. In a structure where the top plate and the side wall are formed from separate components and connected to each other, stress produced by vibrations of the top plate is produced at the connection portion between the top plate and the side wall. This stress may cause detachment between the top plate and the side wall at the connection surface.

Thus, the present disclosure aims to provide a structure in which a top plate and a side wall are connected, and that reduces detachment between the top plate and the side wall at a connection surface.

An embodiment of the present disclosure provides a fluid control device that includes a first flat plate, a second flat plate, and a side wall. The first flat plate includes a vibrator at which a piezoelectric device is disposed, a frame disposed to surround the vibrator, a support member that connects the vibrator and the frame to each other, and a first opening formed between the vibrator and the frame. The second flat plate has a first main surface that faces the vibrator, and includes a second opening. The side wall is disposed between the frame of the first flat plate and the second flat plate to be connected to the first flat plate and the second flat plate.

The second flat plate includes an annular first recess set back from the first main surface. When the fluid control device is viewed in plan in an arrangement direction in which the second flat plate, the side wall, and the first flat plate are arranged in order, an outer circumferential edge of the first recess is positioned outward of an inner wall surface of the side wall.

In this structure, a portion of the second flat plate on which stress caused by vibrations of the second flat plate concentrates is a portion at which a thin portion defined by the first recess in the second flat plate and a thick portion including no first recess are connected. The portion at which the second flat plate and the side wall are connected is different from the portion at which the thin portion and the thick portion are connected. This structure reduces stress produced at the portion at which the second flat plate and the side wall are connected.

According to the present disclosure, detachment between the second flat plate (top plate) and the side wall at a connection surface can be reduced.

### BRIEF DESCRIPTION OF THE SEVERAL VIEWS OF THE DRAWINGS

FIG. 1 is an exploded perspective view of a fluid control device according to a first embodiment.

FIG. 2A is a cross-sectional view of a structure of the fluid control device according to the first embodiment, and FIG. 2B is an enlarged cross-sectional view of a connection portion between a second flat plate and a side wall.

FIG. 3A is a diagram illustrating a simulation result of stress produced at a connection portion between a second flat plate and a side wall in the fluid control device according to the first embodiment of the present disclosure, and FIG. 3B is a diagram illustrating a simulation result of stress produced at a connection portion between a second flat plate and a side wall in a fluid control device according to a comparative example.

FIG. 4A is a graph illustrating the relation between stress and a ratio of a no-connection width to a facing width by which the second flat plate and the side wall face each other, and FIG. 4B is a graph illustrating the relation between stress and a ratio of the depth of a recess to a thickness of the second flat plate.

FIG. 5 is a cross-sectional view of a structure of a fluid control device according to a second embodiment.

FIG. 6 is a cross-sectional view of a structure of a fluid control device according to a third embodiment.

FIG. 7 is a cross-sectional view of a structure of a fluid control device according to a fourth embodiment.

FIG. 8 is an enlarged cross-sectional view of a connection portion between a second flat plate and a side wall of a fluid control device according to a fifth embodiment.

### DETAILED DESCRIPTION OF THE DISCLOSURE

### First Embodiment

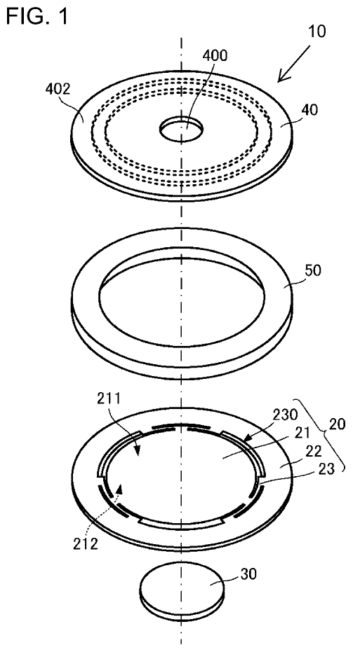

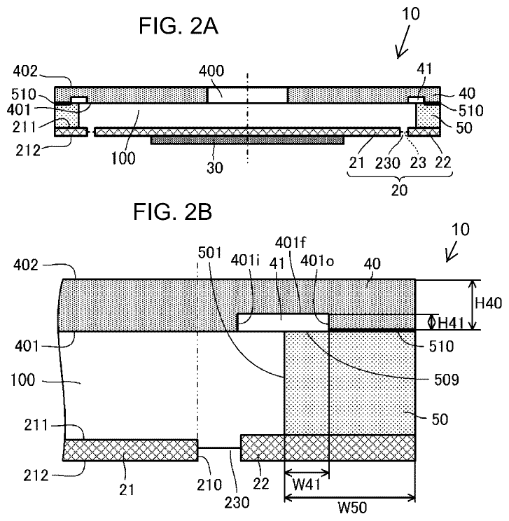

A fluid control device according to a first embodiment of the present disclosure is described with reference to the drawings. FIG. 1 is an exploded perspective view of the fluid control device according to the first embodiment. FIG. 2A is a cross-sectional view of the structure of the fluid control device according to the first embodiment. FIG. 2B is an enlarged cross-sectional view of a connection portion between a second flat plate and a side wall. For ease of description, the drawings of the embodiments described below illustrate components in a partially or entirely exaggerated manner. For readability, some reference signs for components assumed to be uniquely understood have been omitted.

### Structure of Fluid Control Device 10

As illustrated in FIG. 1, FIG. 2A, and FIG. 2B, a fluid control device 10 includes a first flat plate 20, a piezoelectric device 30, a second flat plate 40, and a side wall 50.

The first flat plate 20 is a circular flat plate when viewed in plan. The first flat plate 20 has a circular main surface 211 and a circular main surface 212. The main surface 211 and the main surface 212 are opposite to each other.

The first flat plate 20 includes a vibrator 21, a frame 22, support members 23, and first openings 230. When viewed in plan, the vibrator 21 has a circular shape. When viewed in plan, the frame 22 has an annular shape. The frame 22 surrounds the vibrator 21 along the outer circumference of the vibrator 21.

The support members 23 and the first openings 230 are disposed along the outer circumferential edge of the vibrator 21, and between the vibrator 21 and the frame 22. The first openings 230 extend through the main surface 211 and the main surface 212 of the first flat plate 20.

The support members 23 connect the outer circumferential edge of the vibrator 21 and the inner circumferential edge of the frame 22. For example, the fluid control device 10 includes the multiple support members 23. In the example in FIG. 1, the support members 23 are arranged along the outer circumference of the vibrator 21 at angular intervals of 120°. In the fluid control device 10, the support members 23 are formed to divide a single opening into the first openings 230 at portions of the outer circumferences of the first openings 230. The support members 23 with the width and the shape set as appropriate allow the vibrator 21 to vibrate relative to the frame 22. In other words, the support members 23 support the vibrator 21 while allowing the vibrator 21 to vibrate relative to the frame 22.

Although the vibrator 21 may have a circular shape, the vibrator 21 may also have a substantially circular shape such as an ellipse, or a polygonal shape. The profile of the frame 22, that is, the profile of the first flat plate 20 is not limited to a circle, and may be set as appropriate in accordance with the design of the profile of the fluid control device 10.

The first flat plate 20 is formed from, for example, metal. The first flat plate 20 may be any plate that allows the vibrator 21 to cause bending vibrations due to a distortion of the piezoelectric device 30 described below. The bending vibrations are vibrations that move the main surface 211 and the main surface 212 in a wavelike shape when the vibrator 21 is viewed sideways.

The piezoelectric device 30 includes a disklike piezoelectric body and driving electrodes. The driving electrodes are disposed on both main surfaces of the disklike piezoelectric body.

The piezoelectric device 30 is disposed on the main surface 212 of the vibrator 21. The piezoelectric device 30 is distorted when a driving signal is applied to the driving electrode. This distortion vibrates the vibrator 21 in the above manner.

The second flat plate 40 has a shape of a circular flat plate when viewed in plan. The second flat plate 40 is formed from a material that causes less vibrations, and has a thickness that causes less vibrations than the first flat plate 20. The profile of the second flat plate 40 is substantially the same as the profile of the first flat plate 20. The second flat plate 40 has a circular first main surface 401 and a circular second main surface 402. The first main surface 401 and the second main surface 402 are opposite to each other.

The second flat plate 40 includes a second opening 400. The second opening 400 is a cylindrical through-hole extending through the first main surface 401 and the second main surface 402 of the second flat plate 40. The second opening 400 is formed to include the center of the second flat plate 40 when the second flat plate 40 is viewed in plan.

The second flat plate 40 includes a recess 41. The recess 41 is positioned adjacent to the outer circumferential edge of the second flat plate 40. The recess 41 is set back from the first main surface 401. When viewed in plan, the recess 41 has an annular shape. The recess 41 corresponds to “a first recess” according to the present disclosure.

The recess 41 has an inner circumferential surface 401i, an outer circumferential surface 401o, and a bottom surface (a top surface) 401f. The inner circumferential surface 401i and the outer circumferential surface 401o are parallel to the depth direction of the recess 41. The inner circumferential surface 401i is a surface positioned closer to the center of the annular shape, and the outer circumferential surface 401o is a surface positioned a longer distance apart from the center than the inner circumferential surface 401i in a radial direction of the annular shape. The bottom surface (the top surface) 401f is a surface orthogonal to the depth direction of the recess, and that determines a depth H41 of the recess.

The second flat plate 40 is disposed to have its main surfaces positioned parallel to the first flat plate 20. The first main surface 401 of the second flat plate 40 and the main surface 211 of the first flat plate 20 face each other. The center of the second flat plate 40 when viewed in plan and the center of the vibrator 21 of the first flat plate 20 when viewed in plan substantially coincide.

As in the first flat plate 20, the profile of the second flat plate 40 is not limited to a circular shape, and may be set as appropriate in accordance with the design of the profile of the fluid control device 10.

The side wall 50 is an annular cylinder. The side wall 50 is formed from a material that causes almost no bending vibrations, and that has a thickness causing almost no bending vibrations. The side wall 50 is separate from the first flat plate 20, but the side wall 50 and the first flat plate 20 may be formed in one piece.

The side wall 50 has an inner wall surface 501 and an outer wall surface. When the fluid control device 10 is viewed in plan, the inner wall surface 501 is circular. The inner wall surface 501 is an inner wall surface of the annular cylinder, and the outer wall surface is an outer wall surface of the annular cylinder.

### Form of Connection Between First Flat Plate 20, Second Flat Plate 40, and Side Wall 50

The side wall 50 is disposed between the first flat plate 20 and the second flat plate 40. The end surface of the side wall 50 positioned closer to the first flat plate 20 in the height direction is in contact with and connected to the main surface 211 of the frame 22 of the first flat plate 20. The end surface of the side wall 50 positioned closer to the first flat plate 20 and the main surface 211 of the frame 22 are connected with, for example, an adhesive.

An end surface 509 of the side wall 50 positioned closer to the second flat plate 40 in the height direction is connected to the first main surface 401 of the second flat plate 40. The end surface 509 and the first main surface 401 are connected with an adhesive 510. The end surface 509 and the first main surface 401 are connected with the adhesive 510, but may be connected by any method as long as the end surface 509 and the first main surface 401 that are originally separate from each other are physically connected.

The fluid control device 10 with this structure includes a space surrounded by the first flat plate 20, the second flat plate 40, and the side wall 50. This space serves as a pump chamber 100 of the fluid control device 10.

### More Specific Structure of Second Flat Plate 40 and Side Wall 50

When the fluid control device 10 is viewed in plan (in an arrangement direction in which the second flat plate 40, the side wall 50, and the first flat plate 20 are arranged in order), a portion of the end surface 509 of the side wall 50 positioned closer to the outer wall surface overlaps the first main surface 401 of the second flat plate 40. A portion of the end surface 509 positioned closer to the outer wall surface and the first main surface 401 are connected with the adhesive 510.

When the fluid control device 10 is viewed in plan, a portion of the end surface 509 of the side wall 50 positioned closer to the inner wall surface 501 overlaps the recess 41 in the second flat plate 40. Thus, an edge portion (a corner when viewed sideways) at which the inner wall surface 501 and the end surface 509 of the side wall 50 cross is not connected to the first main surface 401, that is, the second flat plate 40.

### Stress Produced at Connection Portion Between Second Flat Plate 40 and Side Wall 50

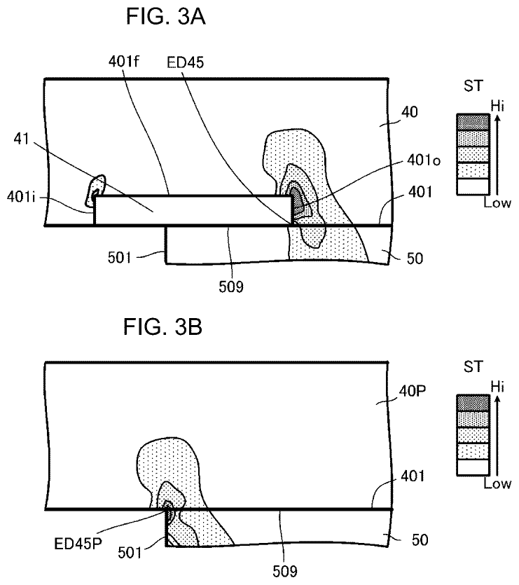

FIG. 3A is a diagram illustrating a simulation result of stress produced at a connection portion between a second flat plate and a side wall in the fluid control device according to the first embodiment of the present disclosure. FIG. 3B is a diagram illustrating a simulation result of stress produced at a connection portion between a second flat plate and a side wall in a fluid control device according to a comparative example. FIG. 3A and FIG. 3B illustrate stress ST produced, when the second flat plate vibrates, in a direction to separate the second flat plate from the side wall.

In the fluid control device 10 with the above structure, a portion of the second flat plate 40 including the recess 41 is a thin portion. Thus, the second flat plate 40 includes a thick portion positioned closer to the center than the recess 41 in the second flat plate 40, a thin portion defined by the recess 41, and a thick portion positioned outward of the recess 41. In this structure, stress concentrates on the connection portion between the thick portion and the thin portion.

Thus, as illustrated in FIG. 3A, a portion in the fluid control device 10 that is subjected to the most stress is the edge portion (the corner when viewed sideways) at which the bottom surface (the top surface) 401f and the outer circumferential surface 401o of the recess 41 cross. Stress produced at an inner end portion ED45 at which the second flat plate 40 and the side wall 50 are connected is smaller than stress produced at the edge portion (the corner when viewed sideways) at which the bottom surface (the top surface) 401f and the outer circumferential surface 401o cross.

Thus, in the fluid control device 10, the portion that is subjected to the most stress is not the inner end portion ED45 at which the second flat plate 40 and the side wall 50 are connected, but the edge portion that defines the recess 41 in the second flat plate 40, which is a portion defined without involving physical connection.

As illustrated in FIG. 3B, in a fluid control device according to a comparative example, in contrast, the portion that is subjected to the most stress is an edge portion at which the inner wall surface 501 and the end surface 509 of the side wall 50 cross. The edge portion corresponds to the inner end portion ED45P according to the comparative example at which the second flat plate 40 and the side wall 50 are connected. More specifically, in the fluid control device according to the comparative example, the portion that is subjected to the most stress is a portion formed by physically connecting the second flat plate 40 and the side wall 50.

As described above, in the fluid control device according to the comparative example, the portion that is subjected to the most stress overlaps the connection portion, whereas in the fluid control device 10, the portion that is subjected to the most stress does not overlap the connection portion, and stress produced at the connection portion is smaller. Thus, the fluid control device 10 can reduce stress produced at the connection portion between the second flat plate 40 and the side wall 50. Thus, the fluid control device 10 can reduce detachment between the second flat plate 40 and the side wall 50 at the connection portion.

As described above, the fluid control device 10 includes the second flat plate 40 having the recess 41. In addition, in the fluid control device 10, the recess 41 does not allow the second flat plate 40 to come into contact with the edge portion at which the inner wall surface 501 and the end surface 509 of the side wall 50 cross, and allows the second flat plate 40 to be connected to the end surface 509 of the side wall 50 at a portion outward of the edge portion. Thus, the fluid control device 10 can reduce detachment at the connection portion between the second flat plate 40 and the side wall 50.

In the fluid control device 10, the recess 41 may not overlap the vibrator 21 when viewed in plan. More specifically, when the fluid control device 10 is viewed in plan, the inner circumferential surface 401i of the recess 41 may be positioned outward of the outer circumferential edge of the vibrator 21. In this structure, the recess 41 does not increase the distance between the vibrator 21 and the second flat plate 40 in the pump chamber 100. This structure can thus reduce degradation of the pump performance of the fluid control device 10.

### Connection Width and Depth of Recess

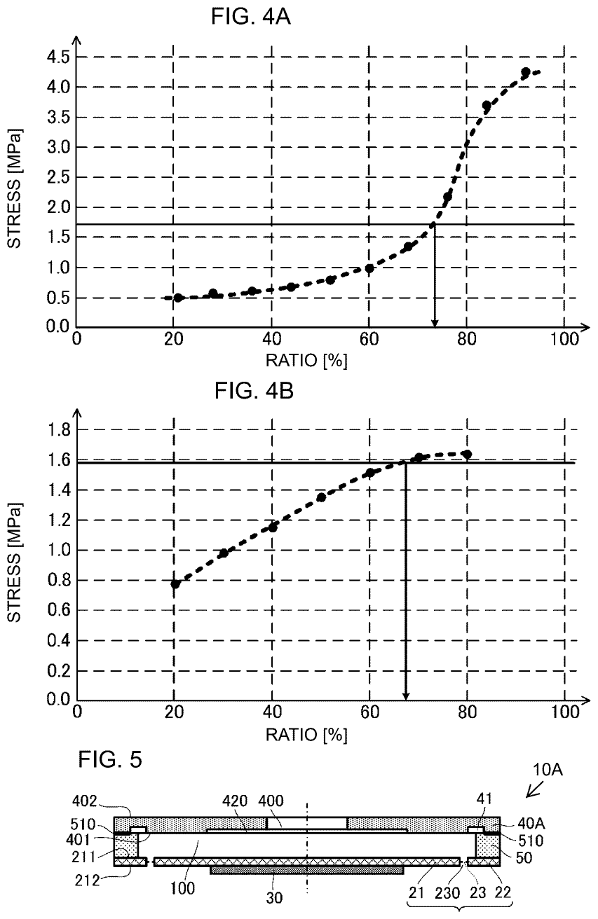

FIG. 4A is a graph illustrating the relation between stress and a ratio of a no-connection width to a facing width by which the second flat plate and the side wall face each other. The solid line indicating stress in FIG. 4A indicates stress in the comparative example.

As illustrated in FIG. 2B, a facing width W50 by which the second flat plate 40 and the side wall 50 face each other is a distance between the inner wall surface 501 and the outer wall surface of the side wall 50. In FIG. 2B, the profile of the second flat plate 40 and the profile of the side wall 50 coincide, and thus, this distance may be set as the facing width W50. However, when the profile of the second flat plate 40 is smaller than the profile of the side wall 50, the facing width W50 is the distance between the inner wall surface 501 of the side wall 50 and the outer circumferential edge of the second flat plate 40 when viewed in plan.

A no-connection width W41 is a distance between the inner wall surface 501 and the outer circumferential surface 401o of the recess 41 when viewed in plan. The ratio in FIG. 4A is calculated by dividing the no-connection width W41 by the facing width W50 and expressed as a percentage.

As illustrated in FIG. 4A, when the no-connection width W41 is less than or equal to about 75% of the facing width W50, stress produced at the connection portion of the fluid control device 10 is smaller than stress produced at the connection portion of the fluid control device according to the comparative example. Thus, in the fluid control device 10, the no-connection width W41 may be less than or equal to about 75% of the facing width W50.

FIG. 4B is a graph illustrating the relation between stress and a ratio of the depth of a recess to a thickness of the second flat plate. The solid line indicating stress in FIG. 4B indicates stress in the comparative example. The ratio in FIG. 4B is calculated by dividing a depth H41 of the recess 41 by the thickness H40 of the second flat plate 40 and expressed as a percentage. The depth H41 of the recess 41 is obtained by subtracting the thickness at the thinnest portion of the recess 41 from the thickness H40 of the second flat plate 40.

As illustrated in FIG. 4B, when the depth H41 of the recess 41 is less than or equal to about 65% of the thickness H40 of the second flat plate 40, stress produced at the connection portion in the fluid control device 10 is smaller than stress produced at the connection portion in the fluid control device according to the comparative example. Thus, in the fluid control device 10, the depth H41 of the recess 41 may be less than or equal to about 65% of the thickness H40 of the second flat plate 40.

### Second Embodiment

A fluid control device according to a second embodiment of the present disclosure is described with reference to the drawings. FIG. 5 is a cross-sectional view of a structure of a fluid control device according to a second embodiment. As illustrated in FIG. 5, a fluid control device 10A according to the second embodiment is different from the fluid control device 10 according to the first embodiment in that it includes a second flat plate 40A. Other components of the fluid control device 10A are the same as those of the fluid control device 10 according to the first embodiment, and thus are not described.

The second flat plate 40A includes a recess 420. The recess 420 is set back from the first main surface 401, and is circular when viewed in plan. The recess 420 is connected to the second opening 400. The recess 420 corresponds to “a second recess” according to the present disclosure.

The fluid control device 10A with this structure can reduce flow path resistance in the space defined by the bottom surface of the recess 420 and a portion of the vibrator 21 overlapping the recess 420 when viewed in plan.

### Third Embodiment

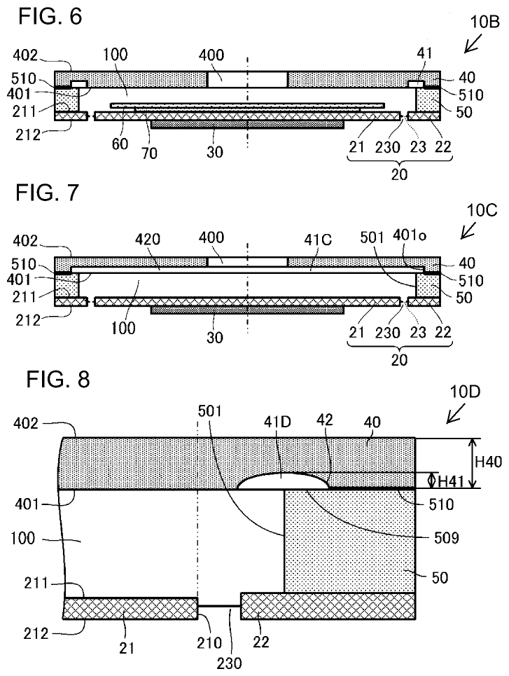

A fluid control device according to a third embodiment of the present disclosure is described with reference to the drawings. FIG. 6 is a cross-sectional view of a structure of a fluid control device according to a third embodiment. As illustrated in FIG. 6, a fluid control device 10B according to the third embodiment is different from the fluid control device 10 according to the first embodiment in that it includes a valve member. Other components of the fluid control device 10B are the same as those of the fluid control device 10 according to the first embodiment, and thus are not described.

The fluid control device 10B includes a valve member. The valve member includes a film 60 and a fastening member 70.

The film 60 is a circular film. The fastening member 70 is a cylinder with a smaller diameter than the film 60. The film 60 is fastened to the main surface 211 of the vibrator 21 with the fastening member 70. A portion of the film 60 near the outer circumferential edge is not fixed with the fastening member 70, and deformed by a fluid flowing in the pump chamber 100. The fluid control device 10B sucks the fluid through the second opening 400 and ejects the fluid through the first openings 230 using deformation of the film 60.

The fluid control device 10B with this structure can achieve a function of more stable flow regulation while reducing detachment between the second flat plate 40 and the side wall 50.

At this time, the recess 41 may not overlap a valve member when the fluid control device 10B is viewed in plan. For example, the inner circumferential surface 401i of the recess 41 may be positioned outward of the outer circumferential edge of the film 60 when the fluid control device 10B is viewed in plan.

The fluid control device 10B can thus reduce the degradation of the flow regulation function by the recess 41.

The structure according to the third embodiment including the valve member is also applicable to a structure according to another embodiment in addition to the structure according to the first embodiment.

### Fourth Embodiment

A fluid control device according to a fourth embodiment of the present disclosure is described with reference to the drawings. FIG. 7 is a cross-sectional view of a structure of a fluid control device according to a fourth embodiment. As illustrated in FIG. 7, a fluid control device 10C according to the fourth embodiment is different from the fluid control device 10 according to the first embodiment in terms of the shape of a recess 41C. Other components of the fluid control device 10C are the same as those of the fluid control device 10 according to the first embodiment, and thus are not described.

In the fluid control device 10C, the second flat plate 40 includes the recess 41C. The recess 41C is circular when viewed in plan. The outer circumferential surface 401o of the recess 41C is positioned outward of the inner wall surface 501 of the side wall 50 when the fluid control device 10C is viewed in plan. The recess 41C corresponds to “a first recess” according to the present disclosure, and can also function as “a second recess” according to the present disclosure.

The fluid control device 10C with this structure can reduce detachment between the second flat plate 40 and the side wall 50 at the connection surface.

### Fifth Embodiment

A fluid control device according to a fifth embodiment of the present disclosure is described with reference to the drawings. FIG. 8 is an enlarged cross-sectional view of a connection portion between a second flat plate and a side wall of a fluid control device according to a fifth embodiment. As illustrated in FIG. 8, a fluid control device 10D according to the fifth embodiment is different from the fluid control device 10 according to the first embodiment in terms of the shape of a recess 41D. Other components of the fluid control device 10D are the same as those of the fluid control device 10 according to the first embodiment, and thus are not described.

The recess 41D in the second flat plate 40 has an arc shape in a cross section viewed sideways. More specifically, the recess 41D has a wall surface 42 with an arc-shaped cross section. When the fluid control device 10D is viewed in plan, the outermost end of the wall surface 42 of the recess 41D is positioned outward of the inner wall surface 501 of the side wall 50.

The fluid control device 10D with this structure can reduce detachment between the second flat plate 40 and the side wall 50 at the connection surface.

The recess may have any shape other than the shapes described above in the embodiments. The shape of the recess may be set as appropriate as long as the outermost end of the recess is positioned outward of the edge portion at which the inner wall surface 501 and the end surface 509 of the side wall 50 cross when the fluid control device is viewed in plan.

(1) A fluid control device, comprising: a first flat plate including a vibrator at which a piezoelectric device is disposed, a frame disposed to surround the vibrator, a support member that connects the vibrator and the frame to each other, and a first opening formed between the vibrator and the frame; a second flat plate having a first main surface that faces the vibrator, and including a second opening; and a side wall that is disposed between the frame of the first flat plate and the second flat plate to be connected to the first flat plate and the second flat plate, wherein the second flat plate includes an annular first recess set back from the first main surface, and wherein when the fluid control device is viewed in plan in an arrangement direction in which the second flat plate, the side wall, and the first flat plate are arranged in order, an outer circumferential edge of the first recess is positioned outward of an inner wall surface of the side wall.

(2) The fluid control device according to (1), wherein, when the fluid control device is viewed in plan in the arrangement direction, an inner circumferential edge of the recess is positioned outward of the vibrator.

(3) The fluid control device according to (1) or (2), wherein the second flat plate includes a second recess that is connected to the second opening and set back from the first main surface.

(4) The fluid control device according to any one of (1) to (3), comprising: a valve member disposed on a surface of the vibrator closer to the second flat plate.

(5) The fluid control device according to (4), wherein, when the fluid control device is viewed in plan in the arrangement direction, an inner circumferential edge of the first recess is positioned outward of the valve member.

(6) The fluid control device according to any one of (1) to (5), wherein a no-connection width between the second flat plate and the side wall is less than or equal to 75% of a distance between the inner wall surface and an outer circumferential edge of the side wall at a portion connected to the second flat plate.

(7) The fluid control device according to any one of (1) to (5), wherein a depth of the first recess is less than or equal to 65% of a thickness of the second flat plate.
10, 10A, 10B, 10C, 10D fluid control device
20 first flat plate
21 vibrator
22 frame
23 support member
30 piezoelectric device
40, 40A second flat plate
41, 41C, 41D recess
42 wall surface
50 side wall
60 film
70 fastening member
100 pump chamber
211, 212 main surface
230 first opening
400 second opening
401 first main surface
401i inner circumferential surface
401o outer circumferential surface
402 second main surface
420 recess
501 inner wall surface
509 end surface
510 adhesive

1. A fluid control device, comprising:
a first flat plate including
a vibrator at which a piezoelectric device is disposed,
a frame disposed to surround the vibrator,
a support member connecting the vibrator and the frame to each other, and
a first opening provided between the vibrator and the frame;
a second flat plate having a first main surface facing the vibrator, and including a second opening; and
a side wall disposed between the frame of the first flat plate and the second flat plate and connected to the first flat plate and the second flat plate,
wherein the second flat plate includes an annular first recess set back from the first main surface, and
wherein when the fluid control device is viewed in plan in an arrangement direction in which the second flat plate, the side wall, and the first flat plate are arranged in order, an outer circumferential edge of the first recess is positioned outward of an inner wall surface of the side wall.

2. The fluid control device according to claim 1,
wherein, when the fluid control device is viewed in plan in the arrangement direction, an inner circumferential edge of the first recess is positioned outward of the vibrator.

3. The fluid control device according to claim 1,
wherein the second flat plate includes a second recess connected to the second opening and set back from the first main surface.

4. The fluid control device according to claim 1, further comprising:
a valve member disposed on a surface of the vibrator closer to the second flat plate.

5. The fluid control device according to claim 4,
wherein, when the fluid control device is viewed in plan in the arrangement direction, an inner circumferential edge of the first recess is positioned outward of the valve member.

6. The fluid control device according to claim 1,
wherein a no-connection width between the second flat plate and the side wall is less than or equal to 75% of a distance between the inner wall surface and an outer circumferential edge of the side wall at a portion connected to the second flat plate.

7. The fluid control device according to claim 1,
wherein a depth of the first recess is less than or equal to 65% of a thickness of the second flat plate.

8. The fluid control device according to claim 2,
wherein the second flat plate includes a second recess connected to the second opening and set back from the first main surface.

9. The fluid control device according to claim 2, further comprising:
a valve member disposed on a surface of the vibrator closer to the second flat plate.

10. The fluid control device according to claim 3, further comprising:
a valve member disposed on a surface of the vibrator closer to the second flat plate.

11. The fluid control device according to claim 2,
wherein a no-connection width between the second flat plate and the side wall is less than or equal to 75% of a distance between the inner wall surface and an outer circumferential edge of the side wall at a portion connected to the second flat plate.

12. The fluid control device according to claim 3,
wherein a no-connection width between the second flat plate and the side wall is less than or equal to 75% of a distance between the inner wall surface and an outer circumferential edge of the side wall at a portion connected to the second flat plate.

13. The fluid control device according to claim 4,
wherein a no-connection width between the second flat plate and the side wall is less than or equal to 75% of a distance between the inner wall surface and an outer circumferential edge of the side wall at a portion connected to the second flat plate.

14. The fluid control device according to claim 5,
wherein a no-connection width between the second flat plate and the side wall is less than or equal to 75% of a distance between the inner wall surface and an outer circumferential edge of the side wall at a portion connected to the second flat plate.

15. The fluid control device according to claim 2,
wherein a depth of the first recess is less than or equal to 65% of a thickness of the second flat plate.

16. The fluid control device according to claim 3,
wherein a depth of the first recess is less than or equal to 65% of a thickness of the second flat plate.

17. The fluid control device according to claim 4,
wherein a depth of the first recess is less than or equal to 65% of a thickness of the second flat plate.

18. The fluid control device according to claim 5,
wherein a depth of the first recess is less than or equal to 65% of a thickness of the second flat plate.
